(19) United States
(12) Patent Application Publication
(10) Pub. No.: US 2026/0339486 A1
(43) Pub. Date: Oct. 29, 2026

(54) METHOD, APPARATUS, DEVICE AND STORAGE MEDIUM FOR CONTENT PRESENTATION

(71) Applicant: Beijing Zitiao Network Technology Co., Ltd., Beijing (CN)

(72) Inventors: Yuxuan Zhao, Beijing (CN); Yang Liu, Beijing (CN)

(21) Appl. No.: 19/116,932

(22) PCT Filed: Sep. 26, 2023
(86) PCT No.: PCT/CN2023/121736

§ 371 Date: Mar. 28, 2025

(30) Foreign Application Priority Data
Sep. 28, 2022 (CN) 202211193819.5

(51) Int. Cl. G06F 3/0483; G06F 3/04847

(52) U.S. Cl. CPC G06F 3/0483; G06F 3/04847

(57) ABSTRACT

According to embodiments of the disclosure, a method, an apparatus, a device and a storage medium for content presentation are provided. The method is implemented at a client of a target participant. The method includes presenting a content presentation page associated with a target conversation; and presenting a set of media content items in the content presentation page. The set of media content items includes media content items respectively posted, outside the target conversation of a current application, by a plurality of participants of the target conversation. The target participant is at least one participant of the plurality of participants.

This application claims the benefit of Chinese Patent Application No. 202211193819.5, filed on Sep. 28, 2022, and entitled “METHOD, APPARATUS, DEVICE AND STORAGE MEDIUM FOR CONTENT PRESENTATION”, the entire content of which is incorporated herein by reference.

### FIELD

Example embodiments of the present disclosure generally relate to the field of computers, and more particularly, to a method, an apparatus, a device, and a computer-readable storage media for content presentation.

### BACKGROUND

Currently, more and more applications are designed to provide various services to users. For example, in a content sharing application, users may create, browse, comment, and forward contents of various types (including media contents such as texts, videos, images, image sets, sounds, etc.). In addition, the content sharing application further allows the user to communicate.

### SUMMARY

In a first aspect of the present disclosure, a method for content presentation is provided. The method is implemented at a client of a target participant, and includes presenting a content presentation page associated with a target conversation; and presenting a set of media content items in the content presentation page. The set of media content items includes media content items respectively posted, outside the target conversation of a current application, by a plurality of participants of the target conversation. The target participant is at least one participant of the plurality of participants.

In a second aspect of the present disclosure, an apparatus for content presentation is provided. The apparatus is implemented at a client of a target participant, and includes: a first presenting module configured to present a content presentation page associated with a target conversation; and a second presenting module configured to present a set of media content items in the content presentation page. The set of media content items includes media content items respectively posted, outside the target conversation of a current application, by a plurality of participants of the target conversation. The target participant is at least one participant of the plurality of participants.

In a third aspect of the present disclosure, an electronic device is provided. The device includes at least one processing unit; and at least one memory coupled to the at least one processing unit and storing instructions executable by the at least one processing unit. The instructions, when executed by the at least one processing unit, cause the device to perform the method of the first aspect.

In a fourth aspect of the present disclosure, a computer-readable storage medium is provided. The medium stores a computer program, and when the computer program is executed by a processor, causes the method of the first aspect to be performed.

It should be understood that the content described in the content part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, in which:

FIG. 1 illustrates a schematic diagram of an example environment in which embodiments of the present disclosure may be implemented;

FIG. 2 illustrates a flowchart of a process for content presentation according to some embodiments of the present disclosure;

FIG. 3A to FIG. 3C illustrate schematic diagrams of example pages related to content presentation according to some embodiments of the present disclosure;

FIG. 4A to FIG. 4C illustrate schematic diagrams of example pages related to content presentation according to some further embodiments of the present disclosure;

FIG. 5A to FIG. 5C illustrate schematic diagrams of example pages related to content presentation according to some further embodiments of the present disclosure;

FIG. 6A to FIG. 6B illustrate schematic diagrams of example pages related to content presentation according to still further embodiments of the present disclosure;

FIG. 7 illustrates a block diagram of an apparatus for content presentation according to some embodiments of the present disclosure; and

FIG. 8 illustrates an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are illustrated in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

In the description of the embodiments of the present disclosure, the term “including” and the like are to be understood as open inclusion, i.e., “including but not limited to”. The term “based on” should be understood as “based at least in part”. The term “one embodiment” or “the embodiment” should be understood as “at least one embodiment”. The term “some embodiments” should be understood as “at least some embodiments”. Other explicit and implicit definitions may also be included below.

It may be understood that the data (including but not limited to the data itself, data acquisition, use, storage, or deletion) involved in the technical solutions of the present disclosure should comply with the requirements of the corresponding laws, regulations and relevant provisions.

It can be understood that before the technical solutions of the embodiments of the present disclosure are used, the relevant users should be informed of the type, the usage scope, the usage scenario of the information in an appropriate manner according to relevant laws and regulations, and authorization of the relevant users should be obtained.

For example, in response to receiving an unsolicited request from a user, prompt information is sent to the relevant user to explicitly remind the relevant user that the operation requested to be executed will need to obtain and use information of the relevant user, such that the relevant user may autonomously select, according to prompt information, whether to provide profile information for software or hardware (such as an electronic device, an application, a server, or a storage medium) that executes the operation of the technical solutions of the present disclosure.

As an optional but non-limiting implementation, in response to receiving an unsolicited request from the relevant user, for example, the prompt information may be sent to the relevant user by a pop-up window, and the prompt information may be presented in the form of text in the pop-up window. In addition, the popup window may also carry a selection control for the user to select ‘agree’ or don't ‘agree’to provide information to the electronic device.

It may be understood that the above notifying and obtaining the user authorization process are merely examples, and do not limit the implementation of the present disclosure, and other methods meeting relevant laws and regulations may also be applied to the implementation of the present disclosure.

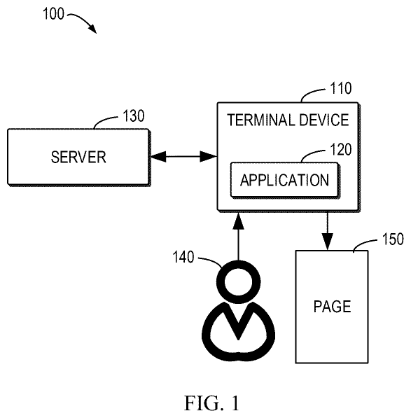

FIG. 1 illustrates a schematic diagram of an example environment 100 in which embodiments of the present disclosure may be implemented. In the example environment 100, the terminal device 110 is installed with an application 120. The user 140 may interact with the application 120 via the terminal device 110 and/or an attachment device of the terminal device 110. The application 120 may be a social application, such as a content sharing application. The application 120 may provide the user 140 with one or more services related to the media content item, including creation, publication, browsing, commenting, forwarding, etc. of the media content item. The media content item here includes contents of one or more types, such as images, image sets, videos, animated GIFs, audio, text, etc.

In the environment 100 of FIG. 1, when the application 120 is active, the terminal device 110 may present a page 150 of the application 120. The page 150 may include various pages that may be provided by the application 120, such as a profile page, a media content details page, a content creation pages, a content publication page, a message page, etc. The application 120 may provide content creation functions, including shooting, uploading, editing, and/or posting media content items.

In some embodiments, the terminal device 110 communicates with the server 130 to provide services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for illustrative purposes only and do not imply any limitation to the scope of the present disclosure.

In a content sharing application, the user is further allowed to establish a conversation communication, in addition to sharing content. For example, the user may initiate conversations with one or more other users, including a one-on-one conversation (also referred to as a private chat or a single chat) or a many-to-many conversation (also referred to as a group chat). Providing conversation communication functions may facilitate user communication and improve emotions between users. Typically, there is no connection between the content communicated in the user conversation and the content created and posted by the user in the application. Specifically, the conversation page aggregates messages sent by a plurality of users participating in the conversation. A user may need to view the media content posted by other users in the content stream of the application or visit profile homepages of other users to view their posted media content. This content presentation method is difficult to provide a unique relationship experience between specific user groups, such as private chat users or group chat users.

According to embodiments of the present disclosure, an improved solution for content presentation is presented. In the solution, in a page associated with a specific conversation, media content items posted, outside of the conversation, by a plurality of participants of the conversation are presented in an aggregated manner. Compared to separately presenting content posted by different users, the content presentation method provided in the present disclosure may realize the aggregated presentation of the content posted by the conversation participant, such that the user may obtain the content related to specific friends.

Some example embodiments of the present disclosure will be described below with continued reference to the accompanying drawings.

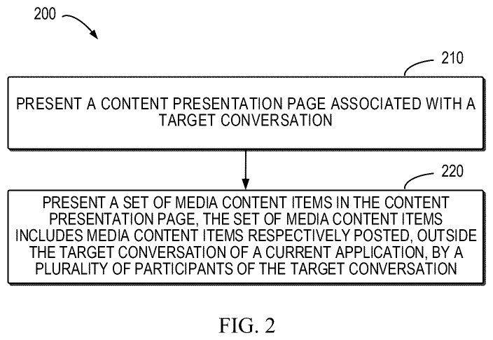

FIG. 2 illustrates a flowchart of a process 200 for content presentation according to some embodiments of the present disclosure. The process 200 may be implemented at a client of a target participant, such as at the terminal device 110. For ease of discussion, the process 200 will be described with reference to the environment 100 of FIG. 1.

At block 210, the terminal device 110 presents a content presentation page associated with a target conversation.

In some embodiments, a specific application, such as the application 120, is run on the terminal device 110, and various pages of the application 120 are presented. The presentation of the page may be based on the operation of the user. The application 120 may provide communication services among users. In the application 120, for example, the user may create one or more conversations. For example, each conversation may correspond to chats with different users and/or groups. For example, a conversation may correspond to a one-on-one chat between one user and another specific user, or a conversation may correspond to a group chat among more than two users. Here, the user participating in the conversation is referred to as a participant in the conversation. For example, the one-on-one chat may involve two participants, and the group chat may involve more than two participants. In the following, the terms “participant” and “user” may be used interchangeably.

Here, the conversation involved in process 200 is referred to as a “target conversation”. The target conversation usually involves a plurality of participants, and the target participant on the terminal device 110 is at least one participant in the plurality of participants.

Furthermore, as will be mentioned below, the application 120 may also allow the user to create and post media content items. The “media content item” may include content of one or more types, such as images, image sets, videos, GIFs, audio, text, etc. The user at the terminal device 110 may view his/her created and posted media content item, and may also view media content items posted by other specific users (if he/she has the access permission).

When the conversation function is provided, in a target conversation page for sending and receiving messages, other associated pages may be presented based on the user selection. An example of the page may include a setting page corresponding to the target conversation. In the setting page, one or more configuration functions for the target conversation may be provided.

For ease of understanding, example pages will be described below with reference to the accompanying drawings. It should be understood that the pages illustrated in the drawings are merely illustrative, and there may be a variety of different page designs in practice. The various graphical elements in the page may have different arrangements, different names, and different visual representations, one or more of which may be omitted or replaced, and one or more other elements may also be present. Embodiments of the present disclosure are not limited in this respect.

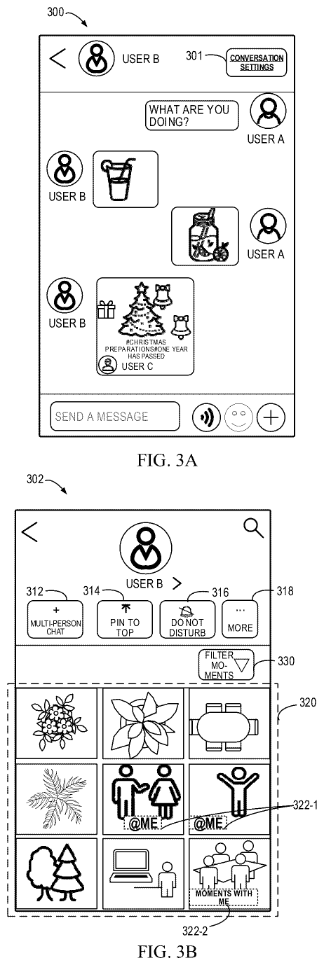

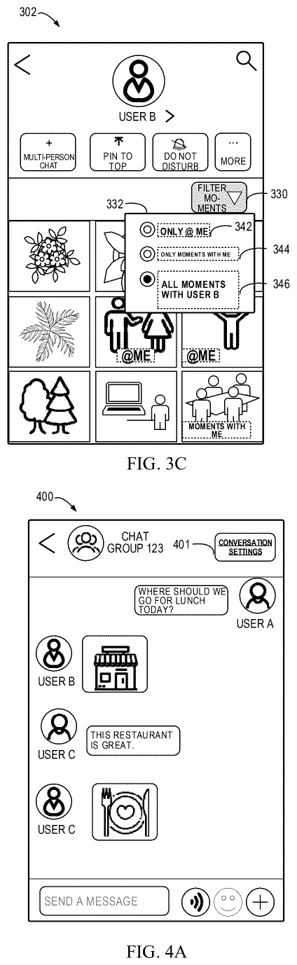

FIG. 3A illustrates an example conversation page 300 of the application 120. The conversation page 300 provides a one-on-one conversation window for a user (e.g., “User A”) and a further user (e.g., “User B”) of the application 120. Assuming that the conversation page 300 is presented to the user “User A” at the terminal device 110, the “User A” is referred to as the target participant in the conversation. At the terminal device of the “User B”, the conversation page presented may be slightly different, for example, the messages from both parties in the conversation may be presented in different locations on the page.

The conversation page 300 may support message sending and receiving by the participants in the conversation and may present messages in the conversation. The message may include content of various types, such as text, images, videos, links, and the like. The content may include content uploaded locally or captured in real time by the user, shared content, forwarded content, and the like. In some examples, the conversation page 300 further supports other communication modes of the participant, such as voice communication, video communication, and the like.

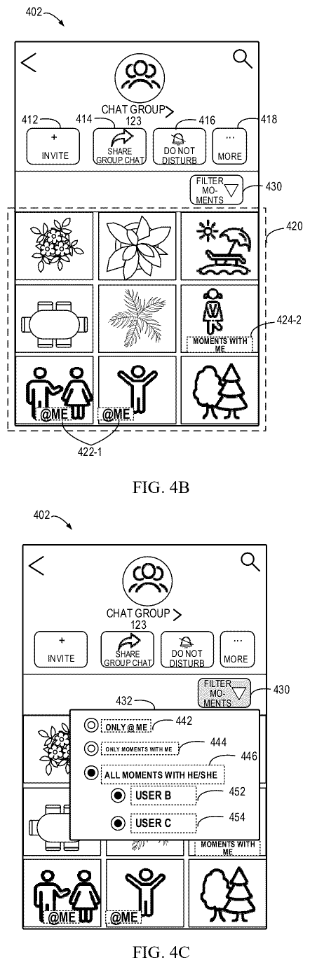

FIG. 4A illustrates a further example conversation page 400 of the application 120. The conversation page 400 provides a group chat conversation window for the “User A” and a plurality of other users (e.g., “User B” and “User C”) of the application 120. Assuming that the conversation page 400 is presented to the user “User A” at the terminal device 110, the “User A” is referred to as the target participant in the conversation. At the terminal devices of other participants in the group chat, the conversation pages presented may be slightly different, for example, the messages from both parties in the conversation may be presented in different locations on the page. The content presentation of the conversation page of the group chat may be similar to the content presentation of the conversation page of the one-on-one chat, and details are not described herein again.

In some embodiments, on the conversation page of the target conversation, an entry to the setting page corresponding to the target conversation may be provided, such as the “conversation settings” entry 301 on the conversation page in FIG. 3A, the “conversation settings” entry 401 on the conversation page in FIG. 4A. When a selection of the entry is detected, a setting page (such as the setting page 302 in FIG. 3B, or the setting page 402 in FIG. 4B) corresponding to the target conversation may be presented. The setting page may provide one or more configuration functions related to the target conversation.

For example, in the example of FIG. 3B, the setting page 302 corresponding to the one-on-one chat provides a “Multi-person Chat” function 312 for initiating the group chat with more users; a “Pin to Top” function 314 for pinning the current conversation to the top of the conversation stream; a “Do Not Disturb” function 316 for enabling and disabling new message notifications for the current conversation; and a “More” function 318 for deploying more functions that may be configured for the current conversation. In the example of FIG. 4B, the setting page 402 corresponding to the group chat provides an “Invite” function 412 for inviting more users to join the group chat; a “Share Group Chat” function 414 for sharing the current group chat with other users; a “Do Not Disturb” function 416 for enabling and disabling new message notifications for the current conversation; and a “More” function 418 for deploying more functions that may be configured for the current conversation. Certainly, only example functions in the setting page of the conversation are given here. In practical applications, different setting pages may be designed as needed.

With reference back to FIG. 2, at block 220, a set of media content items is presented in the content presentation page. The set of media content items presented includes media content items respectively posted, outside the target conversation, by a plurality of participants of the target conversation of the current application.

The media content item posted, outside the target conversation, by the participant does not include the media content item sent as the message in the target conversation, but may include the media content item created and posted by the participant through the content publication page of the application. This type of media content item is sometimes also referred to as “work”. In general, the user participating in the conversation may create and send respective one or more media content items in the current application. In some embodiments, the media content item posted by each user may be viewed by accessing the user's profile page. Alternatively, the media content items posted by a plurality of users may also be pushed as a content stream on a specific page of the application.

In an embodiment of the present disclosure, the specific content presentation page further provides an aggregated presentation of media content items posted, outside the conversation, by the user in the conversation. In some embodiments, the media content item presented may include the non-text media content item, such as may include images, image sets, videos, GIFs, and the like. In some embodiments, the content presentation page may include a conversation setting page.

For example, FIG. 3B illustrates that in the area 320 of the setting page 302 corresponding to the conversation between the “User A” and the “User B”, a set of media content items posted, outside the current conversation, by the two conversation participants “User A” and “User B” is presented. FIG. 4B illustrates that in the area 420 of the setting page 402, a set of media content items posted, outside the current conversation, by three conversation participants “User A”, “User B” and “User C” in the group chat is presented.

The presentation method may provide a content aggregation space for a specific user group, enabling the user to browse the simultaneous presentation of his/her posted content and the content posted by one or more friends. For example, in the example of FIG. 3B, the “User A” may browse the dedicated content aggregation space with the “User B”. In the example of FIG. 3B, the “User A” may also browse the dedicated content aggregation space for the three-person group with “User B” and “User C”. This provides convenience for viewing the works of members in the specific group.

Although in the example embodiments of the accompanying drawings, it is illustrated that the set of media content items posted, outside the target conversation, by a plurality of participants is presented in the setting page corresponding to the target conversation. In some embodiments, the set of media content items may also be presented in other appropriate content presentation pages, in addition to the setting page corresponding to the target conversation. For example, the set of media content items may be presented in a separate page associated with the target conversation, and the entry to the page may be configured in the conversation page or other pages. For example, the separate page may not provide functions related to conversation settings as illustrated in FIG. 3B or FIG. 4B, but rather directly present the set of media content items aggregated from a plurality of participants.

In some embodiments, the set of media content items from a plurality of participants may be presented in a tile view, such as the example tile views in FIG. 3B and FIG. 4B. In some embodiments, the set of media content items may also be presented in other views, such as a stacked view or the like. In some embodiments, the set of media content items may be organized into image sets or videos, etc., and may be automatically played or manually played based on the user operation.

In some embodiments, when the set of media content items from the plurality of participants is presented, the media content items may be arranged in a mixed manner based on one or more attributes of a predetermined type of the media content items in the set. In some embodiments, the attributes may include a time attribute, such as the publication time of the media content item. This arrangement allows the user to view the mixed arrangement of his/her work and other friends' works on the timeline.

In some embodiments, when the media content items are arranged in the mixed manner based on the time attribute, the various media content items in the set of media content items may be presented in a reverse time order. In other words, among the media content items from the plurality of participants, the media content items that is posted closer to the current time may be arranged and presented in a more prominent location, while the media content item that is posted earlier may be arranged and presented in a less prominent location. For example, in the area 320 of the page 302 or the area 420 of the page 402, the set of media content items of the corresponding participant may be presented in the reverse order of publication time from left to right and from top to bottom. The media content item in the top-left corner of the area is the latest media content item. In other embodiments, the various media content items in the set of media content items may also be presented in the time order based on the publication time. As such, the media content items with earlier publication times may be arranged and presented in more prominent locations.

In some embodiments, alternatively, the media content items of the plurality of participants may also be arranged based on attributes of other types related to the media content item, in addition to the publication time. Additionally, or alternatively, for example, it may also be arranged in the mixed manner based on the popularity of the various media content items (e.g., the number of likes, the number of views, etc.), the association relationship between the media content item and the target participant, etc. The different arrangement manners may be configured according to practical applications, and the scope of embodiments of the present disclosure is not limited in this respect.

In some embodiments, the various participants in the target conversation are authors. When a media content item is posted, the access permission of the media content item may be configured as needed. The access permission may include a full public access permissions, a partial public access permission, or a prohibited public access permission. The media content item with the full public access permission may be accessed by any other user. The media content item with the partial public access permission may be accessed by one or more specified users. The media content item with the prohibited public access permission may only be accessible by the creator.

In accordance with a determination that the access permission of the media content item may be configured, when the media content items of the plurality of participants are aggregated and presented, in the case where the current page is to be presented to the target participant of the plurality of participants, the presented media content item in the set of media content items may be determined based on the access permission of the target participant to the media content item. Specifically, in the page presented to the target participant, the presented set of media content items includes media content items that the target participant has access to. It should be noted that, the user's access permission to the work may be changed, and accordingly, the content of the presented set of media content items will also change with the access permission. For example, the access permission may be changed based on the forwarding operation of the user. For a target work that is originally accessible only by the creator, after the target work is forwarded by the creator to the target conversation, the various participants in the target conversation have the access permission to the target work, and the various participants may view the target work in the set of media content items presented on the content presentation page.

Generally, the target participant has the access permission to the media content item posted by himself/herself. For a further participant in the target conversation, the target participant may access some or all of the media content items posted by the further participant, depending on the access permission configuration of the further participant to the media content item posted by himself/herself. The media content item that the target participant has access to may be presented in the corresponding page. Based on the access permission, in the pages viewed by different users, the presented set of media content items will be different.

In some embodiments, based on the access permission, a server of the application 120 may filter the media content item that may be presented on the page presented to the target participant, and provide the set of media content items that the target participant has the access permission to the terminal device 110 for presentation. In some embodiments, the presented set of media content items may also be filtered based on the access permission locally at the terminal device 110 or at other appropriate devices.

In some embodiments, the media content item posted by the target participant or other participants may include information related to the target participant. For example, in some applications, when the user posts a certain media content item, the user may mention the target participant, for example, by using “@” symbol followed by the target participant's username or other methods to remind the target participant, such that the target participant may receive the notification related to the media content item.

In some embodiments, when the set of media content items of the plurality of participants is aggregated and presented, the media content item having the specific association relationship with the target participant may be identified with a specific identifier. The predetermined identifier may be presented, on the content presentation page, in association with the corresponding media content item. For example, in the example of FIG. 3B, the media content item mentioning the target participant (i.e., “User A”) is identified by the identifier 322-1, and the media content item including the tag of the at least one target participant or including interaction operations such as the target participant participating in comments is identified by the identifier 322-2. The tag of the at least one target participant may be added by the poster of the media content item when the media content item is created. Similarly, in the example of FIG. 4B, the media content item mentioning the target participant (i.e., “User A”) is identified by the identifier 422-1, and the media content item including the tag of the target participant or including interaction operations such as the target participant participating in comments is identified by the identifier 422-2. Furthermore, by triggering the identifier 322-1 or the identifier 322-2, all media content items under the identifier category may be displayed.

In addition to mentioning the target participant, other information related to the target participant may also be identified in the media content item. For example, the target participant may interact with a certain media content item, such as commenting, liking, and forwarding. In some embodiments, the interaction behavior (such as the number of comments, the number of likes, whether it is forwarded, the number of forwards, etc.) of the target participant may be identified in the presented media content item.

In some embodiments, the set of media content items to be presented to the target participant may also be determined based on an association relationship between the media content item and the target participant. In some embodiments, the association relationship between the media content item and the target participant may be determined based on methods such as whether the media content item mentions the target participant. When a media content item mentions the target participant, it may be determined that the association relationship between the media content item and the target participant meets a predetermined condition. In some embodiments, the association relationship between the media content item and the target participant may further be determined based on an interaction history between the target participant and the media content item. The interaction behavior such as commenting, liking, and forwarding of a media content item by the target participant may be used to indicate the association relationship between the target participant and the media content item. A greater number of comments, the occurrence of the liking behavior, and the number of forwarding being greater than a predetermined value may indicate that the media content item satisfies a predetermined association relationship with the target participant.

In some embodiments, the set of media content items presented in the content presentation page associated with the target conversation may include a media content item whose association relationship with the target participant satisfies the predetermined condition. In some examples, for some further participant, it may be determined that the association relationship between the posted media content item and the target participant satisfies the predetermined condition, and thus it may be included in the presented set of media content items.

In some embodiments, the target participant may also be allowed to filter the media content item to be presented as needed. The target participant may provide a content filtering indication to indicate the media content item that may be included in the set of media content items to be presented. In some embodiments, the content filtering indication may indicate an expected association relationship (such as a specific association relationship type) between the media content item and the target participant. In some embodiments, the content filtering indication may indicate one or more first participants in a plurality of participants of the target conversation. The target participant may expect to display the aggregation of media content items posted by himself/herself and the first participant in the mixed manner. By providing the content filtering indication, the target participant may filter and aggregate the media content items of interest to other users as needed. This may be particularly beneficial when there are numerous media content items posted by a plurality of participants and/or a large number of conversation participants. Furthermore, the content filtering indication may further indicate the media content item including the tag of at least one target participant or including interaction operations such as the target participant participating in comments.

In some embodiments, a filtering control may be provided in the page to facilitate the user (e.g., the target participant) to enter the content filtering indication. For example, in the page 302 of FIG. 3B, a “Filter Moments” control 330 is provided. As illustrated in FIG. 3C, when the control is selected, a drop-down menu 332 that includes a plurality of filtering options may be provided. The “Only @Me” option 342 is used to filter the media content item that mentions the target participant, The “Moment only with Me” option 344 is used to filter the media content item that includes the target participant tag or includes interaction operations such as the target participant participating in comments. The “All Moments with User B” option 346 is used to indicate to remain all the media content items posted by the User B.

Similarly, a filter control “Filter Moments” 430 is also provided in the page 302 of FIG. 4B. As illustrated in FIG. 4C, when the control is selected, a drop-down menu 432 that includes a plurality of filtering options may be provided. The “Only @Me” option 432 and the “Moment only with Me” option 444 are similar to the examples in FIG. 3C. The “All Moments with He/She” option 446 is used to filter the first participant among a plurality of other participants in the group, it includes sub-options corresponding to the plurality of other participants, such as the “User B” sub-option 452 and the “User C” sub-option 454. With the option 446 and its sub-option, the target participant (for example, the User A) may filter the media content item of the first user in the group chat, and may hide the media content item of the un first user.

In some embodiments, in the current page associated with the target conversation, the media content items involved in the target conversation may also be aggregated into a further set of media content items (for ease of discussion, sometimes referred to as a “second set of media content items”), in addition to aggregating the set of media content items (for ease of discussion, sometimes referred to as a “first set of media content items”)posted, outside the conversation, by the plurality of participants of the conversation. In some embodiments, the media content items sent by a plurality of participants in the target conversation may be aggregated into a further set of media content items. The media content item sent in the conversation may be the media content item uploaded locally to the target conversation by the participant. In some embodiments, the media content items shared by the plurality of participants into the target conversation may be aggregated into a further set of media content items. The shared media content item may be, for example, the media content item posted in the application 120 and/or other associated applications. In some embodiments, the set of media content items to be presented may include non-text messages, such as images, image sets, videos, GIFs, etc., sent or shared in the target conversation.

With the presentation of different set of media content items, in the page associated with the target conversation, the user may view the aggregation of works posted by himself/herself and his/her friends, and view the media content item involved in the history record of the current conversation.

In some embodiments, a plurality of navigation tags may be provided in the page associated with the target conversation, and different sets of media content may be navigated to with different navigation tags.

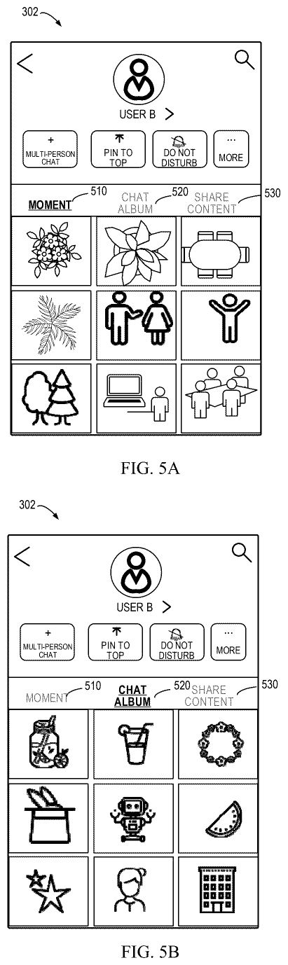

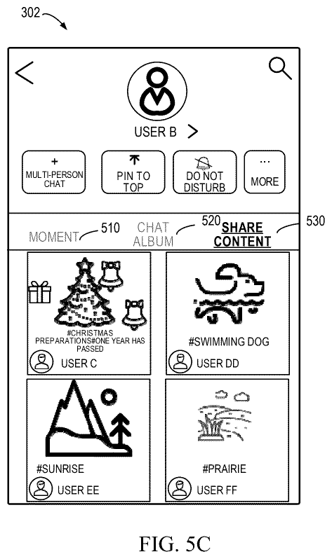

FIG. 5A to FIG. 5C illustrate examples of further configuring a plurality of navigation tags in the setting page 302 corresponding to the one-on-one chat conversation in FIG. 3A. In this example, the navigation tag “Moment” 510 corresponds to a set of media content items posted, outside the target conversation, by a plurality of participants of the target conversation. The navigation tag “Chat Album” 520 corresponds to a set of media content items sent by the plurality of participants in the target conversation. The navigation tag “Share Content” 530 corresponds to a set of media content items shared by the plurality of participants into the target conversation.

In response to a selection of a navigation tag in the page, the corresponding set of media content items may be presented. For example, in the example of FIG. 5A, assuming that the navigation tag “Moment” 510 in the page 302 is selected by default, the set of media content items corresponding to the navigation tag may be presented when the page 302 is switched to. In the example of FIG. 5B, when the user selects the navigation tag “Chat Album” 520, the local media content items sent by the “user A” and “user B” in the one-on-one chat during the conversation are presented. In the example of FIG. 5C, when the user selects the navigation tag “Share Content” 530, the media content items shared by the “User A” and “User B” from other data sources during the conversation are presented.

In some embodiments, the presentation manner of the set of media content items sent and shared by the plurality of participants in the target conversation may be similar to the presentation manner of the set of media content items posted, outside the target conversation, by the plurality of participants. For example, the media content items may be arranged in the time order or the reverse time order based on their publication time (e.g., the sending time, the sharing time, etc. in the conversation). The set of media content items may be presented in a tile view, other views, or other manners in the page.

In the examples of FIG. 5A to FIG. 5C, although the media content items sent and shared by the plurality of participants in the target conversation are presented in different sets of media content items, in some embodiments, the media content items may also be presented in a single set of media content items in the mixed manner. For example, a single navigation tag may be provided in the page, and the mixed set of media content items is presented when the navigation tag is selected.

For the group chat conversation as illustrated in FIG. 4A to FIG. 4C, although not specifically illustrated in the drawings, different sets of media content items may also be presented in a similar manner as discussed with respect to FIG. 5A to FIG. 5C.

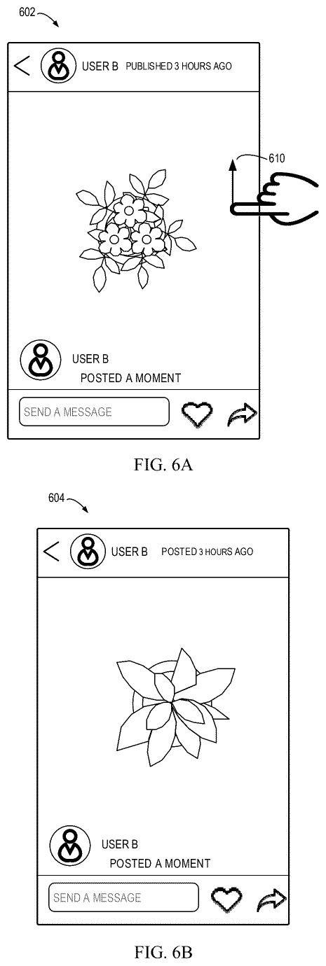

In some embodiments, when the set of media content items respectively posted, outside the target conversation, by a plurality of participants of the target conversation, the user is further allowed to click to view detailed information of the specific media content item. For example, when a selection of a media content item is detected, a detail page corresponding to the media content item may be presented. For example, FIG. 6A illustrates a detail page 602 of a media content item being selected.

In some embodiments, when a media content item is selected for detailed viewing, a content stream manner may be switched to, to view the set of media content items. Specifically, the various media content items in the set of media content items may be organized into a content stream. The content stream may be in the form such as a long page composed of media content items, a video merged from media content items, etc. The media content items may be organized based on the publication time, either in the reverse time order or the time order.

When specific switching is detected in the detail page of the currently presented media content item, in the content stream, a detail page corresponding to a further media content item adjacent to the currently presented media content item is switched to in sequence. As an example, the switching may include, e.g., a specific gesture (e.g., a sliding gesture), a sliding on a specific switching control, a voice control instruction, a triggering of a hardware key, etc. Embodiments of the present disclosure are not limited in this regard.

As an example, in the information stream organized in the reverse time order, when the detected switching includes an upward sliding gesture to switch to the media content earlier posted, in the content stream, the earlier posted media content item adjacent to the current media content item may be switched to. For example, an upward sliding gesture is detected in the detail page 602 illustrated in FIG. 6A, the detail page 604 of the further media content item as illustrated in FIG. 6B may be switched to. In this way, the user may sequentially browse different media content items in the content stream mode.

In some embodiments, for the set of media content items sent and/or shared by the plurality of participants in the target conversation, a detail pages of the single media content item may also be viewed in a similar manner, and detailed information of other media content items may be sequentially viewed in the content stream mode.

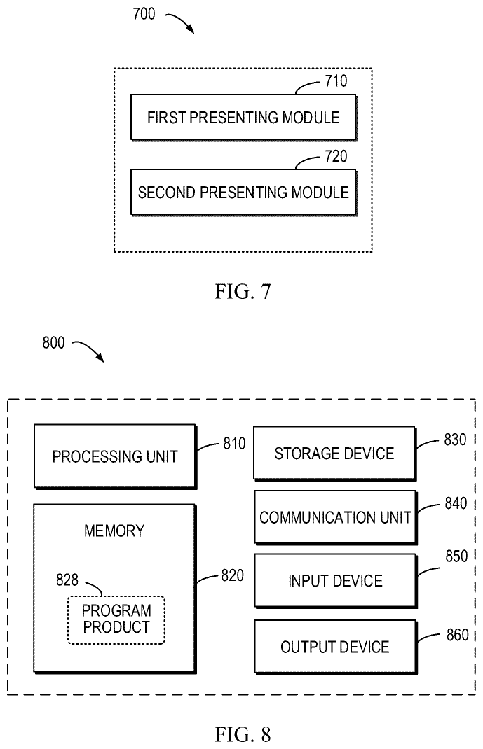

FIG. 7 illustrates a schematic block diagram of an apparatus 700 for content presentation according to some embodiments of the present disclosure. The apparatus 700 may be implemented at the terminal device 110 or included in the terminal device 110. The various modules/components in the apparatus 700 may be implemented by hardware, software, firmware, or any combination thereof.

The apparatus 700 includes a first presenting module 710 configured to present a content presentation page associated with a target conversation. The apparatus 700 further includes a second presenting module 720 configured to present a set of media content items in the content presentation page. The set of media content items includes media content items respectively posted, outside the target conversation of a current application, by a plurality of participants of the target conversation. The target participant is at least one participant of the plurality of participants.

In some embodiments, the page is presented to a target participant of the plurality of participants, and the media content item in the set of media content items is determined based on at least one of: an access permission of the target participant to the media content item, an association relationship between the media content item and the target participant, or a content filtering indication of the target participant.

In some embodiments, the content filtering indication is configured to indicate at least one of: an expected association relationship between a media content item and the target participant, or one or more first participants in the plurality of participants.

In some embodiments, the second presenting module includes an identifier presenting module configured to present a predetermined identifier in association with a media content item in the set of media content items. The predetermined identifier indicates an association relationship between the media content item and the target participant.

In some embodiments, the second presenting module 720 includes a time-based presenting module configured to arrange the media content items of the plurality of participants in a mixed manner based on predetermined type attributes of the media content items in the set of media content items.

In some embodiments, the second presenting module 720 includes a first navigation-tag-based presenting module configured to in response to a selection of a first navigation tag of a plurality of navigation tags in the content presentation page, present the set of media content items.

In some embodiments, the set of media content items includes a first set of media content items. The apparatus 700 further includes: a second navigation-tag-based presenting module configured to in response to a selection of a second navigation tag of the plurality of navigation tags, present a second set of media content items. The second set of media content items includes at least one of: media content items sent by the plurality of participants in the target conversation, or media content items shared by the plurality of participants into the target conversation.

In some embodiments, the apparatus 700 further includes: a detail page presenting module configured to in response to a selection of a first media content item in the set of media content items, present a first detail page corresponding to the first media content item.

In some embodiments, the media content items in the set of media content items are organized into a content stream. The apparatus 700 further includes: a detail page switching module configured to in response to a switching operation in the first detail page, switch to a second detail page corresponding to a second media content item adjacent to the first media content item in the content stream.

In some embodiments, the content presentation page includes a setting page corresponding to the target conversation.

FIG. 8 illustrates a block diagram of an electronic device 800 in which one or more embodiments of the present disclosure may be implemented. It should be understood that the electronic device 800 illustrated in FIG. 8 is merely exemplary and should not constitute any limitation on the functionality and scope of the embodiments described herein. The electronic device 800 illustrated in FIG. 8 may be configured to implement the terminal device 110 in FIG. 1.

As illustrated in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor systems, a plurality of processing units execute computer-executable instructions in parallel to improve parallel processing capabilities of electronic device 800.

Electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 830 may be a removable or non-removable medium and may include a machine-readable medium, such as a flash drive, magnetic disk, or any other medium, which may be capable of storing information and/or data (e.g., training data for training) and may be accessed within electronic device 800.

The electronic device 800 may further include additional removable/non-removable, volatile/non-volatile storage media. Although not illustrated in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not illustrated) by one or more data media interfaces. The memory 820 may include a computer program product 828 having one or more program modules configured to perform various methods or actions of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not illustrated) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not illustrated).

According to example implementations of the present disclosure, a computer-readable storage medium having computer-executable instructions stored thereon is provided. The computer-executable instructions are executable by a processor to implement the method described above. According to example implementations of the present disclosure, a computer program product is further provided. The computer program product is tangibly stored on a non-transitory computer-readable medium and includes computer-executable instructions. The computer-executable instructions are executable by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a specific manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for content presentation, implemented at a client of a target participant, and comprising:
presenting a content presentation page associated with a target conversation; and
presenting a set of media content items in the content presentation page, the set of media content items comprising media content items respectively posted in a current application, except for the target conversation of the current application, by a plurality of participants of the target conversation;
wherein the target participant is at least one participant of the plurality of participants.

2. The method of claim 1, wherein a media content item in the set of media content items is determined based on at least one of:
an access permission of the target participant to the media content item;
an association relationship between the media content item and the target participant, or
a content filtering indication of the target participant.

3. The method of claim 2, wherein the content filtering indication is configured to indicate at least one of:
an expected association relationship between a media content item and the target participant, or
one or more first participants in the plurality of participants.

4. The method of claim 1, wherein presenting the set of media content items comprises:
presenting a predetermined identifier in association with a media content item in the set of media content items, the predetermined identifier indicating an association relationship between the media content item and the target participant.

5. The method of claim 1, wherein presenting the set of media content items comprises:
arranging the media content items of the plurality of participants in a mixed manner based on predetermined type attributes of the media content items in the set of media content items.

6. The method of claim 1, wherein presenting the set of media content items comprises:
in response to a selection of a first navigation tag of a plurality of navigation tags in the content presentation page, presenting the set of media content items.

7. The method of claim 6, wherein the set of media content items comprises a first set of media content items, and the method further comprises:
in response to a selection of a second navigation tag of the plurality of navigation tags, presenting a second set of media content items, the second set of media content items comprising at least one of:
media content items sent by the plurality of participants in the target conversation, or
media content items shared by the plurality of participants into the target conversation.

8. The method of claim 1, further comprising:
in response to a selection of a first media content item in the set of media content items, presenting a first detail page corresponding to the first media content item.

9. The method of claim 8, wherein media content items in the set of media content items are organized into a content stream, and the method further comprises:
in response to a switching operation in the first detail page, switching to a second detail page corresponding to a second media content item adjacent to the first media content item in the content stream.

10. The method of claim 1, wherein the content presentation page comprises a setting page corresponding to the target conversation.

11-18. (canceled)

19. An electronic device, comprising:
at least one processing unit; and
at least one memory coupled to the at least one processing unit and storing instructions executable by the at least one processing unit, the instructions, when executed by the at least one processing unit, causing the apparatus to perform operations comprising:
presenting a content presentation page associated with a target conversation; and
presenting a set of media content items in the content presentation page, the set of media content items comprising media content items respectively posted in a current application, except for the target conversation of the current application, by a plurality of participants of the target conversation;
wherein the target participant is at least one participant of the plurality of participants.

20. A computer readable storage medium having stored thereon a computer program that, when executed by a processor, performing operations comprising:
presenting a content presentation page associated with a target conversation; and
presenting a set of media content items in the content presentation page, the set of media content items comprising media content items respectively posted in a current application, except for the target conversation of the current application, by a plurality of participants of the target conversation;
wherein the target participant is at least one participant of the plurality of participants.

21. The electronic device of claim 19, wherein a media content item in the set of media content items is determined based on at least one of:
an access permission of the target participant to the media content item;
an association relationship between the media content item and the target participant, or
a content filtering indication of the target participant.

22. The electronic device of claim 21, wherein the content filtering indication is configured to indicate at least one of:
an expected association relationship between a media content item and the target participant, or
one or more first participants in the plurality of participants.

23. The electronic device of claim 19, wherein presenting the set of media content items comprises:
presenting a predetermined identifier in association with a media content item in the set of media content items, the predetermined identifier indicating an association relationship between the media content item and the target participant.

24. The electronic device of claim 19, wherein presenting the set of media content items comprises:
arranging the media content items of the plurality of participants in a mixed manner based on predetermined type attributes of the media content items in the set of media content items.

25. The electronic device of claim 19, wherein presenting the set of media content items comprises:
in response to a selection of a first navigation tag of a plurality of navigation tags in the content presentation page, presenting the set of media content items.

26. The electronic device of claim 26, wherein the set of media content items comprises a first set of media content items, and wherein the operations further comprise:
in response to a selection of a second navigation tag of the plurality of navigation tags, presenting a second set of media content items, the second set of media content items comprising at least one of:
media content items sent by the plurality of participants in the target conversation, or
media content items shared by the plurality of participants into the target conversation.

27. The electronic device of claim 19, wherein the operations further comprise:
in response to a selection of a first media content item in the set of media content items, presenting a first detail page corresponding to the first media content item.

28. The electronic device of claim 27, wherein media content items in the set of media content items are organized into a content stream, and the operations further comprise:
in response to a switching operation in the first detail page, switching to a second detail page corresponding to a second media content item adjacent to the first media content item in the content stream.
